(19) United States
(12) Patent Application Publication
(10) Pub. No.: US 2009/0174329 A1
(43) Pub. Date: Jul. 9, 2009

(54) PLASMA DISPLAY PANEL

(75) Inventors: Masahiro Sawa, Miyazaki (JP); Koji Ohira, Miyazaki (JP)

Correspondence Address: MILES & STOCKBRIDGE PC, 1751 PINNACLE DRIVE, SUITE 500, MCLEAN, VA, 22102-3833, US

(73) Assignee: Hitachi Plasma Display Limited, Miyazaki (JP)

(21) Appl. No.: 12/301,459

(22) PCT Filed: Jul. 20, 2006
(86) PCT No.: PCT/JP2006/314429

§ 371 Date: Nov. 18, 2008

(51) Int. Cl. H01J 17/49

(52) U.S. Cl. 313/584

(57) ABSTRACT

A plasma display panel, in which discharge gas is filled in a space between a pair of substrates facing each other, has a plurality of display electrodes which extend in the horizontal direction and address electrodes which extend in the vertical direction and cross with the display electrodes, formed to the pair of substrates; and lattice-shaped ribs having vertical ribs and horizontal ribs that demarcate unit emission areas and formed on one of the substrates, wherein the rib has a pattern which partially becomes narrower from a first width to a second width, and returns to a first width in plan view so that the height of the second width portion is lower than the height of the first width portion. Thereby a plasma display panel having a rib structure with improved exhaust conductance can be provided.

### TECHNICAL FIELD

The present invention relates to a plasma display panel for which exhaust conductance is improved, and more particularly to a plasma display panel in which an exhaust conductance in the sealing step is improved by improving a lattice-shaped rib structure formed on a back substrate to demarcate unit emission areas.

### BACKGROUND

Recently increasingly larger screens are demanded for plasma display panels (hereafter PDP). Currently available commercial PDPs are an AC 3 electrodes surface discharge type. FIG. 1 is a perspective view depicting a configuration of a conventional PDP. On a front substrate 11, a plurality of display electrodes 40, which extend in the horizontal direction, a dielectric layer 17 which coats the display electrodes 40, and a protective layer 18 thereof, are formed, and on a back substrate 21, a plurality of address electrodes A which extend in the vertical direction crossing the display electrodes, a dielectric layer 24 which coats the address electrodes A, ribs 29H and 29V which are lattice-shaped ribs (also called a closed type, box type and waffle type) to demarcate unit emission areas (discharge cells) where the address electrodes and display electrodes cross, and a fluorescent substance 28 on the dielectric layer which covers the address electrodes and side walls of the ribs, are formed.

Then the front substrate and back substrate are sealed with the discharge space there between. In the sealing step, the edges of the front substrate and back substrate are sealed with a sealing agent, the inside is exhausted via a vent hole and vent tube created in the back substrate, then discharge gas, such as a mixed gas of Ne and Xe, is filled, and the vent tube is chipped off (closed). This internal exhaust step is a step of removing the moisture absorbed in the protective film 18 and impurities inside the panels, so that a brightness drop and voltage fluctuation due to the deterioration of fluorescent substance, and brightness unevenness due to voltage fluctuation, are suppressed.

As FIG. 1 shows, the ribs 29 are lattice-shaped ribs, formed of vertical ribs 29V which extend in the vertical direction and horizontal ribs 28H which extend in the horizontal direction, whereby the unit emission areas (discharge cells) C are demarcated. In each unit emission area C, a display electrode pair 40 which extends in the horizontal direction, and an address electrode A which extends in the vertical direction, are disposed.

By enclosing 4 sides of a unit emission area C by lattice-shaped ribs and forming a fluorescent substance on the 4 side walls of the ribs, the surface area of the fluorescent substance, which is excited by ultraviolet rays during discharge, is increased so that emission efficiency can be increased. As a result, high brightness can be maintained even if the unit emission areas become smaller because of further refinement. Since the unit emission areas C are enclosed by the lattice-shaped ribs, the interference of discharge in the unit emission areas C, which are adjacent to each other vertically and horizontally, can be avoided, and error discharge can be prevented.

By the lattice-shaped ribs, discharge interference among unit emission areas can be avoided, and emission efficiency of the fluorescent substance can be increased. A problem of lattice-shaped ribs, however, is that exhaust conductance drops in the internal exhaust during the sealing step. Particularly, the exhaust conductance drops more as a portion gets closer to the center of the panel. Improvements in the exhaust conductance is a challenge that must be met in PDPs of which screen size is increasing.

A rib structure with improved exhaust conductance is disclosed in the following Patent Documents 1, 2, 3 and 4. Patent Document 1 discloses an exhaust conductance in the horizontal direction that is improved by creating spaces in the horizontal ribs. However, nothing is mentioned about the improvement of exhaust conductance in the vertical direction. Patent Document 2 discloses that the width of a horizontal rib is wider than that of a vertical rib, so that the horizontal ribs are formed to be lower by tensile stress in the high temperature baking step of ribs made of glass paste. In other words, an improvement of the exhaust conductance in the vertical direction is shown, but an improvement of the exhaust conductance in the horizontal direction is not provided. Patent Document 3 discloses that the height of the crossing portion of a horizontal rib and vertical rib is lower than other portions. And Patent Document 4 discloses that the height of the ribs is partially decreased by changing the material constituting each portion of a rib, so that exhaust conductance is improved.

### Patent Document 1: Japanese Patent Application Laid-Open No. 2000-311612

### Patent Document 2: Japanese Patent Application Laid-open No. 2002-83545

### Patent Document 3: Japanese Patent Application Laid-open No. 2005-26050

### Patent Document 4: Japanese Patent Application Laid-open No. 2005-347045

As mentioned above, if lattice-shaped ribs are formed, exhaust conductance in the sealing step drops. In other words, in the sealing step, internal exhausting is performed in a state of the front substrate and back substrate glued together, so as to remove moisture and such impurities as organic substances inside the panel. If the internal exhaust is insufficient, the fluorescent substance deteriorates, causing a drop in brightness, voltage fluctuation and display unevenness on the panel surface due to voltage fluctuation.

The above mentioned Patent Documents 1 to 4 disclose a lattice-shaped rib structure where the heights of the ribs are partially low, but none of these result in sufficient improvement. In the case of Patent Documents 1 and 2, for example, exhaust conductance is improved in either the vertical or horizontal direction, but not in both directions. In Patent Document 3, ribs are formed partially low at the crossing positions of the ribs. In Patent Document 4, a complicated manufacturing processing, including a change in materials constituting the ribs, is required, so this is not a practical approach for improvement.

### DISCLOSURE OF THE INVENTION

With the foregoing in view, it is an object of the present invention to provide a plasma display panel having a rib structure where exhaust conductance is improved with a simple configuration, and a drop in emission efficiency is suppressed.

To achieve the above object, a first aspect of the present invention is a plasma display panel, in which discharge gas is filled in a space between a pair of substrates facing each other, having: a plurality of display electrodes which extend in the horizontal direction and address electrodes which extend in the vertical direction and cross with the display electrodes, formed to the pair of substrates; and lattice-shaped ribs having vertical ribs and horizontal ribs that demarcate unit emission areas, and formed on one of the substrates. And the rib has a pattern which partially becomes narrower from a first width to a second width, and returns to the first width in a plan view, so that the height of the second width portion is lower than the height of the first width portion.

Since the first rib partially has a second width which is narrower, the height thereof can be low in the high temperature baking step due to the heat contraction function.

To achieve the above object, a second aspect of the present invention is a plasma display panel in which discharge gas is filled in a space between a pair of substrates facing each other, having: a plurality of display electrodes which extend in the horizontal direction and address electrodes which extend in the vertical direction and cross with the display electrodes, formed to the pair of substrates; and lattice-shaped ribs formed of vertical ribs and horizontal ribs that demarcate unit emission areas, are formed on one of the substrates, characterized in that the horizontal ribs demarcating unit emission areas are connected by the vertical ribs, and have a ladder formation including a pair of sub-horizontal walls and sub-vertical walls connecting the sub-horizontal walls, and having a plurality of intermittent spaces in plan view. This height of the horizontal ribs is lower than that of the vertical ribs, so as to improve exhaust conductance in the vertical direction. The width of the sub-vertical wall is narrower than that of the vertical rib, thereby the height of the sub-vertical wall is partially lower, so as to improve exhaust conductance in the horizontal direction.

According to the second aspect, both the exhaust conductance in the vertical direction and the exhaust conductance in the horizontal direction are improved.

To achieve the above object, a second aspect of the present invention is a plasma display panel in which discharge gas is filled in a space between a pair of substrates facing each other, having: a plurality of display electrodes which extend in the horizontal direction and address electrodes which extend in the vertical direction and cross with the display electrodes, formed to the pair of substrates; and lattice-shaped ribs having vertical ribs and horizontal ribs that demarcate unit emission areas where the display electrodes and address electrodes cross, and formed on one of the pair of substrates. The horizontal ribs of the lattice-shaped ribs are connected by the vertical ribs and have a ladder formation having a pair of sub-horizontal walls and sub-vertical walls connecting the sub-horizontal walls, and having a plurality of intermittent spaces inside in plan view, and the width of the sub-vertical wall is narrower than that of the vertical rib so that the height thereof is formed to be partially low.

According to the third aspect, the width of the sub-vertical wall is decreased, and height thereof is partially decreased, so the exhaust conductance in the horizontal direction can be improved.

The exhaust conductance in the vertical direction and horizontal direction can be improved while having a lattice-shaped rib structure. Since the height of the sub-vertical wall constituting the horizontal rib in the boundary between the unit emission areas is decreased by narrowing the width thereof, the discharge interference prevention function in the emission area is not affected.

### BRIEF DESCRIPTION OF THE DRAWINGS

FIG. 1 is a perspective view depicting a configuration of a conventional PDP.

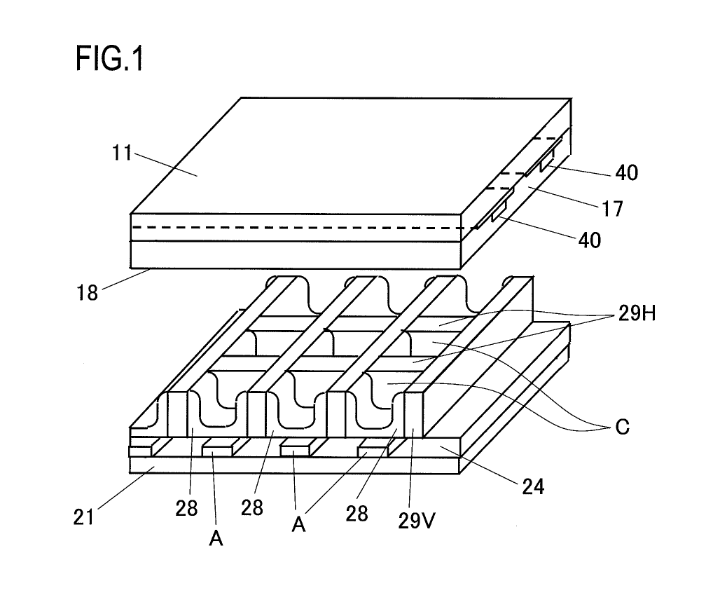

FIG. 2 is a plan view depicting an example of lattice-shaped ribs.

FIG. 3 is a plan view of lattice-shaped ribs according to the first embodiment.

FIG. 4 are cross-sectional views of A-A′ and B-B′ in FIG. 3.

FIG. 5 shows other cross-sectional views of A-A′ and B-B′ in FIG. 3.

FIG. 7 is a partial cross-sectional view along the address electrode in FIG. 6.

FIG. 8 is a plan view depicting the ribs and different display electrodes overlaid thereon according to the first embodiment.

FIG. 9 is a partial cross-sectional view along the address electrode in FIG. 8.

FIG. 10 is a plan view depicting lattice-shaped ribs according to a second embodiment.

FIG. 11 shows cross-sectional views of C—C′ and D-D′ in FIG. 10.

FIG. 12 is a figure showing cross-sectional views of C-C′ and D-D′ different the view in FIG. 10.

FIG. 13 is a cross-sectional view depicting a manufacturing process to form the ribs of the present embodiment.

FIG. 14 is a cross-sectional view depicting a manufacturing process to form the ribs of the present embodiment.

FIG. 15 is a plan view depicting variant forms of the ribs according to the first embodiment.

FIG. 16 is a plan view depicting variant forms of the ribs according to the first embodiment.

FIG. 17 is a plan view depicting a variant form of the ribs according to the second embodiment.

FIG. 18 is a plan view depicting a variant form of the ribs according to the first embodiment.

### BEST MODE FOR CARRYING OUT THE INVENTION

Embodiments of the present invention will now be described with reference to the drawings. The technical scope of the present invention, however, is not limited to these embodiments, but extend to matters stated in Claims and equivalents thereof.

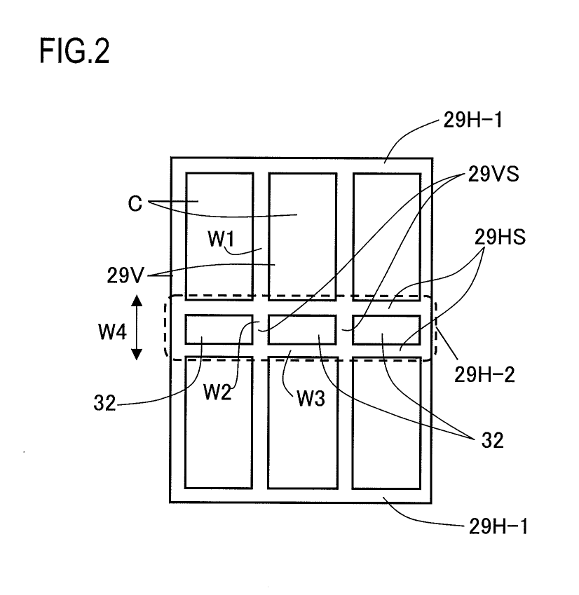

FIG. 2 is a plan view depicting an example of lattice-shaped ribs. This example shows ribs having 6 unit emission areas (cells) C, formed of a total of 3 horizontal ribs 29H-1 and 29H-2 which extend in the horizontal direction, and a total of 4 vertical ribs 29V which connect these vertical ribs and extend in the vertical direction, and these horizontal ribs and vertical ribs form a lattice-shaped structure. With width W4 of one horizontal rib 29H-2 is wider than the width W1 of the vertical rib 29V and the width of the horizontal rib 29H-1. In the horizontal rib 29H-2, a space 32 is intermittently created inside in plan view, so as to be have a ladder formation comprised of a pair of sub-horizontal walls 29HS and sub-vertical walls 29VS which connect them. These ribs and sub-walls are formed by patterning a low melting point glass paste, then baking it in the baking step, and the height thereof changes due to the heat contraction characteristics in the baking step.

According to the above mentioned Patent Document 2, the width W4 of the horizontal rib 29H-2 in FIG. 2 is formed to be wider than those of other ribs, so the height after baking becomes lower than those of other ribs because of the heat compression function. Therefore the horizontal rib 29H-2 between areas adjacent to each other in the vertical direction, out of the 6 unit emission areas, becomes low, which improves the exhaust conductance in the vertical direction in the sealing step. In the horizontal rib 29H-2, the space 32 is intermittently formed in plan view, but even when these spaces 32 are formed, the horizontal rib 29H-2, comprised of sub-horizontal walls 29HS and sub-vertical walls 29VS, is subject to the heat contraction function, as integral ribs having the width W4.

### First Embodiment

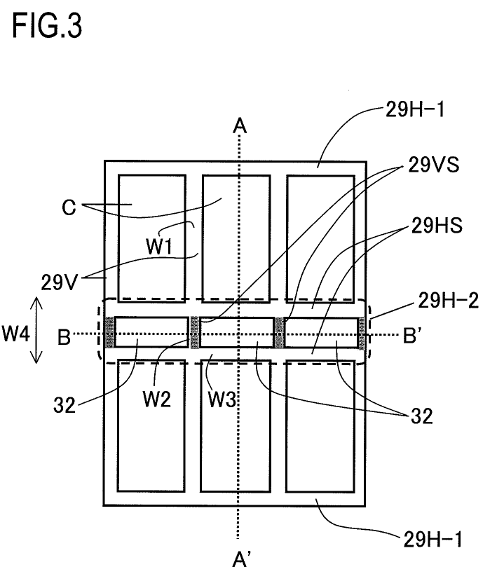

FIG. 3 is a plan view of lattice-shaped ribs according to the first embodiment. Just like FIG. 2, this example shows ribs having 6 unit emission areas (cells), comprised of a total of 3 horizontal ribs 29H-1 and 29H-2 which extend in the horizontal direction, and a total of 4 vertical ribs 29V which connect these horizontal ribs and extend in the vertical direction, and these horizontal ribs and vertical ribs form a lattice-shaped structure. The width W4 of the horizontal rib 29H-2 and the ladder formation of the horizontal rib 29H-2 are also the same as FIG. 2. A difference from FIG. 2 in the rib structure of FIG. 3 is that the width W2 of the sub-vertical wall 29VS is narrower than the width W1 of the vertical rib 29V.

In other words, according to the rib structure in FIG. 3, in one continuous rib in the vertical direction, comprised of the vertical ribs 29V and the sub-vertical wall 29VS connected to them, the width W2 of the sub-vertical wall 29VS is formed to be narrower than that of the vertical ribs 29V, so that the height of the sub-vertical wall 29VS becomes partially low due to the heat contraction function in the baking step, whereby the exhaust conductance in the horizontal direction is improved. This principle is based on the fact that the rib is formed so that the width thereof partially becomes narrow, then the height of the narrow portion becomes low due to the heat contraction characteristic when the rib is baked.

Also in the rib structure in FIG. 3, the width W4 of the horizontal rib 29H-2 is increased appropriately, just like FIG. 2, so that the height thereof becomes lower than the vertical rib 29V, and the exhaust conductance in the vertical direction is improved as well. This heat contraction function is as stated in the above mentioned Patent Document 2.

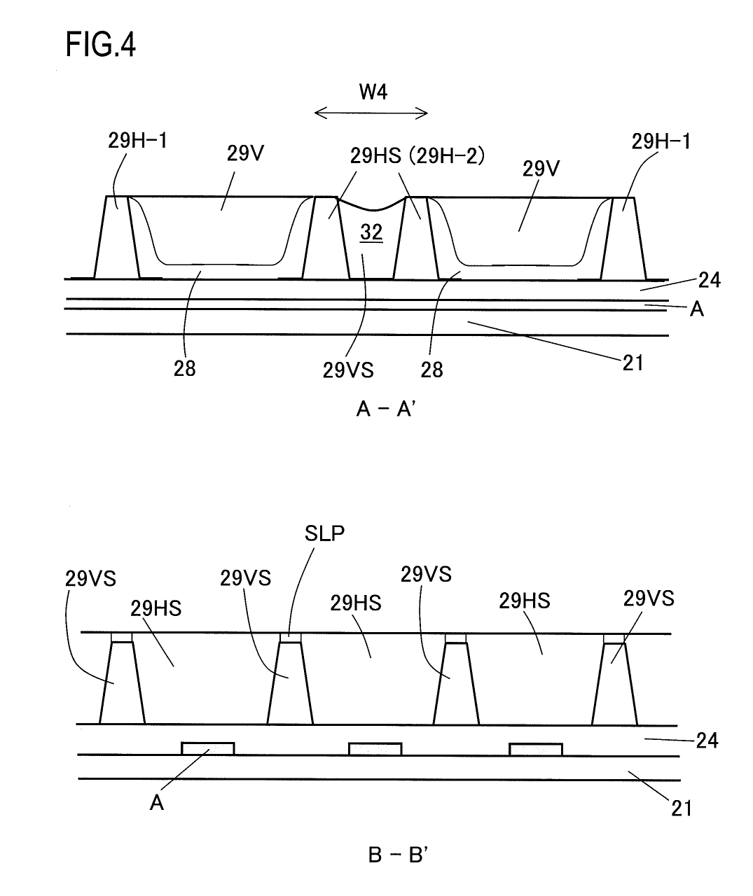

FIG. 4 are cross-sectional views of A-A′ and B-B′ in FIG. 3. In these cross-sections, the address electrodes A are formed on the back substrate 21, the dielectric layer 24 coats thereon, and the ribs 29 are formed thereon. The fluorescent substance 28 is formed on the dielectric layer 24 and on the side faces of the ribs 29.

In the A-A′ sectional view, 3 horizontal ribs 29H-1, 29H-2 and 29H-1 are shown, which are connected with the vertical ribs 29V, and in the horizontal rib 29H-2, the space 32 is created by a pair of sub-horizontal walls 29HS and the sub-vertical walls 29VS connecting the sub-horizontal walls. The width W2 of the sub-vertical wall 29VS is formed to be narrower than those of the other vertical ribs 29V and the sub-horizontal walls 29HS, therefore the height thereof is partially lower at the center portion due to heat contraction during the baking step.

In the B-B′ sectional view, 4 sub-vertical walls 29VS and the sub-horizontal wall 29HS connecting these sub-vertical walls are shown, the height of the sub-vertical walls 29VS is lower, and the slope SLP is shown on the top portions thereof.

As these cross sectional views show, the sub-vertical walls 29VS are partially low, so through-spaces are created between the sub-vertical walls 29VS and the front substrate in the horizontal direction in FIG. 3, which improves the exhaust conductance in the horizontal direction. In other words, the exhaust conductance in the page face direction of the A-A′ sectional view and the horizontal direction in the B-B′ sectional view in FIG. 4 are improved. In FIG. 4, the height of the horizontal rib 29H-2 is the same as the height of the vertical rib 29V.

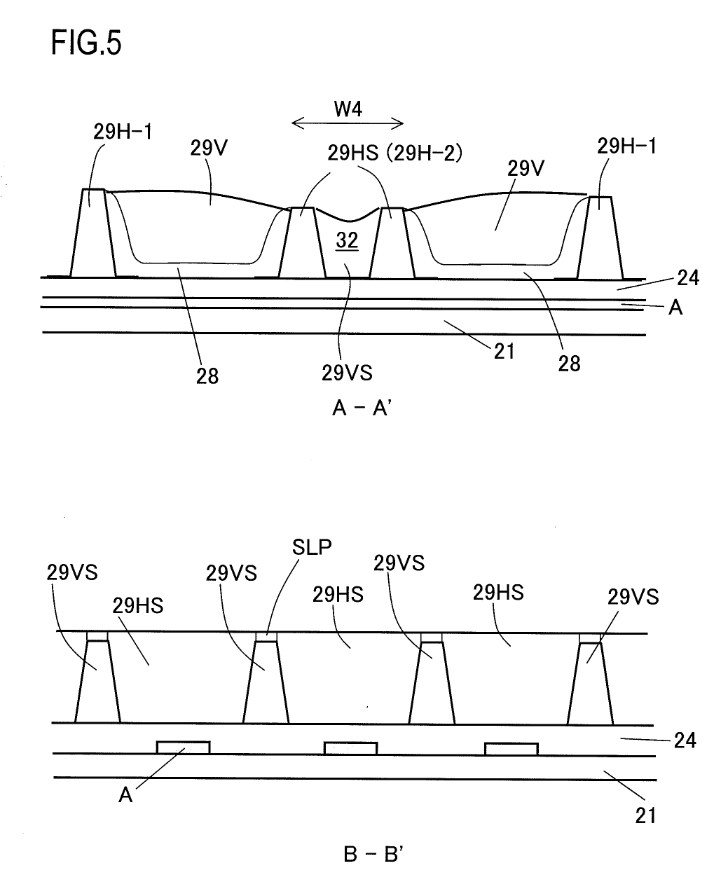

FIG. 5 shows other cross-sectional views of A-A′ and B-B′ in FIG. 3. In this example, as A-A′ sectional view shows, the width W4 of the horizontal rib 29H-2 is appropriately wider than those of the other ribs, and the entire horizontal rib 29H-2 is formed to be lower than the vertical ribs 29V and other horizontal barrier ribs 29H-1, due to the heat contraction function. The sub-vertical walls 29VS are formed to be even lower, since the width W2 is narrower. Thereby the exhaust conductance in the horizontal direction in FIG. 3, that is the exhaust conductance in the page face direction of the A-A′ sectional view and the horizontal direction in the B-B′ sectional view in FIG. 4 are further improved.

FIG. 6 is a plan view depicting the ribs and the display electrodes overlaid thereon according to the first embodiment. In FIG. 6, 4 ribs 29, shown in the plan view in FIG. 3, are disposed in the vertical direction. The widths of the sub-vertical walls constituting the horizontal rib 29H-2 are narrower, although this is not apparent in FIG. 6. Each rib unit 29 is arrayed via the space 30. In the drawing to the right in FIG. 6, the display electrodes 40 and the address electrodes A (broken line) are shown overlapping the ribs 29. The display electrode 40 is comprised of a transparent electrode 41 formed of an ITO, for example, and a bus electrode 42, which is formed overlapping the transparent electrode at the center thereof, and is made of Cr/Cu/Cr, and the bus electrode 42 overlaps the horizontal ribs 29H-1 or 29H-2, and a vertical pair of display electrodes 40 is disposed in each unit emission area C. The display electrode 40 is a common electrode shared by the unit emission areas which are vertically adjacent.

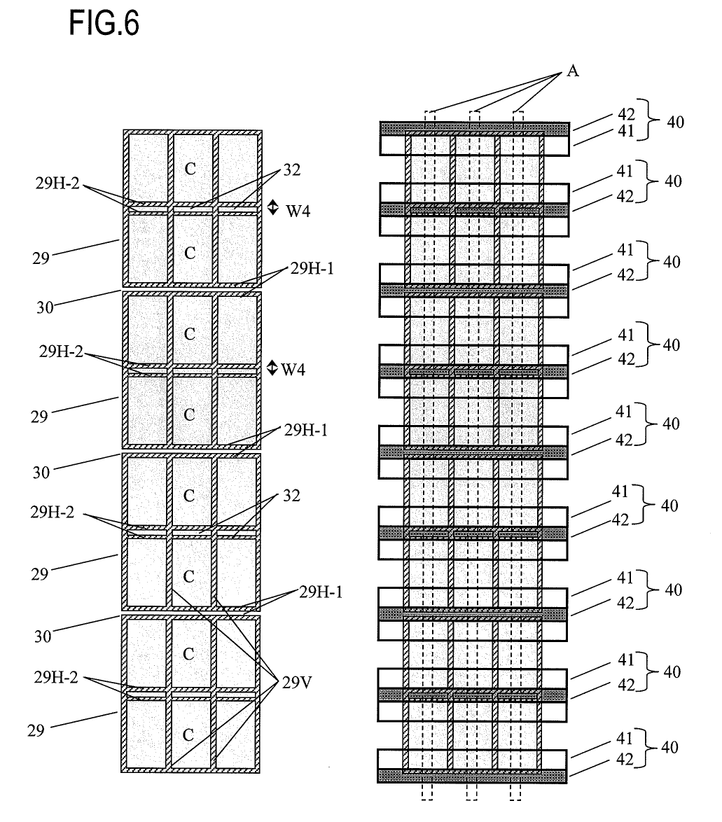

FIG. 7 is a partial cross-sectional view along the address electrode in FIG. 6. This cross-sectional view shows the front substrate 11 and the back substrate 21. On the front substrate 11, the display electrodes 40, each of which is comprised of the transparent electrode 41 and the bus electrode 42, and the dielectric layer 17 which coats thereon, and the protective layer 18, made of MgO, which coats thereon, are formed. On the back substrate 21, the address electrode A, the dielectric layer 24, the ribs 29 and the fluorescent substance 28, are formed. The height of a pair of sub-horizontal walls 29HS, constituting the horizontal rib 29H-2, is formed to be lower than that of the vertical rib 29V, and a center portion of the sub-vertical wall 29VS, which connects the pair of sub-horizontal walls 29HS, is also formed to be lower. Therefore the space 34, from the protective layer 18 of the front substrate 11, is sufficiently created, and exhaust conductance, in a direction perpendicular to the page face, is improved. The bus electrodes 42 of the display electrode 40 are formed over the horizontal ribs 29H-1 and 29H-2, and do not block the unit emission areas C.

As FIG. 6 shows, the rib units 29 are arranged via the spaces 30, so these spaces 30 also improve exhaust conductance in a direction perpendicular to the page face. However all the horizontal ribs 29H may be formed to be the ladder type horizontal ribs 29H-2, without arranging the rib units via the spaces 30. In this case as well, the horizontal rib 29H-2 is formed to be lower than that of other ribs, and the sub-vertical wall 29VS constituting the horizontal rib 29H-2 is also formed to be low, so the exhaust conductance in the horizontal direction in FIG. 6 is improved.

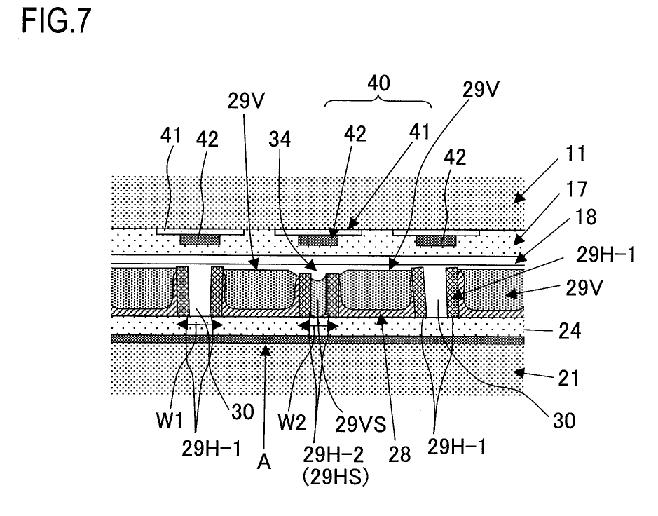

FIG. 8 is a plan view depicting the ribs and different display electrodes overlaid thereon according to the first embodiment. The plan view of the ribs at the left in FIG. 8 is the same as that of the ribs in FIG. 6. The display electrode 40 at the right of FIG. 8 is comprised of a pair of X and Y electrodes 40 disposed on each unit emission area C, unlike the display electrode in FIG. 6. A separate display electrode 40 is used respectively in each of the unit emission areas which are adjacent vertically. In FIG. 8, the bus electrodes and the transparent electrodes are omitted.

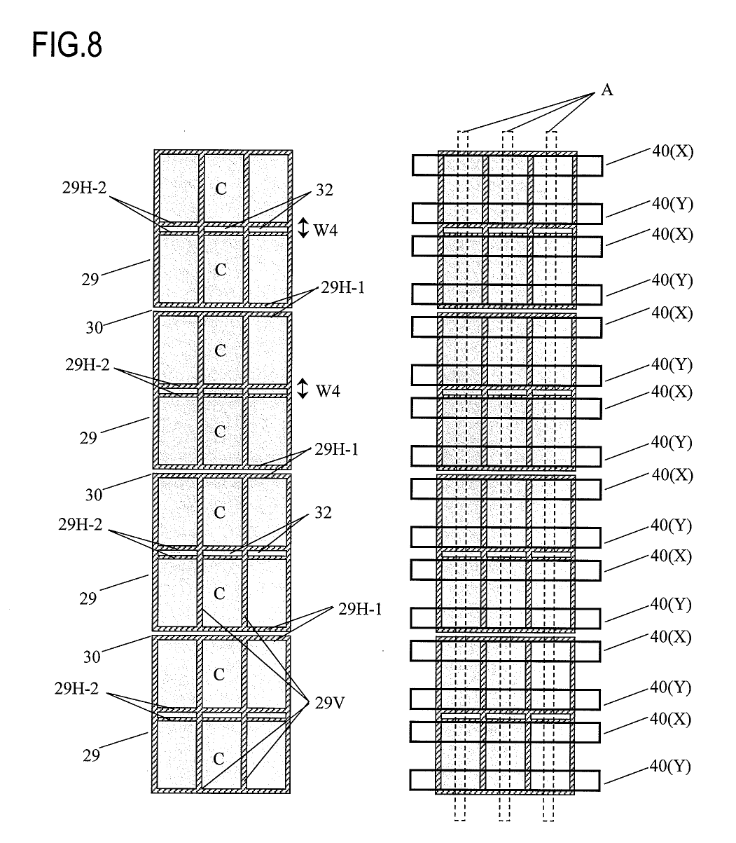

FIG. 9 is a partial cross-sectional view along the address electrode in FIG. 8. This cross-sectional view is the same as FIG. 7, except for the display electrodes 40 and the light shielding film 43 absent in FIG. 7. The display electrode 40 is comprised of a pair of display electrodes disposed on each unit emission area on which the fluorescent substance 28 is formed, and each display electrode 40 is comprised of a transparent electrode 41 and the bus electrode 42. In a non-emission area of the pair of display electrodes 40, a dark colored light shielding film 43 is formed, so as to prevent the fluorescent material 28 inside from being exposed to the front substrate 11 side.

In the case of FIG. 9 as well, the space 34 from the protective layer 18 of the front substrate 11, is sufficiently created, and exhaust conductance in a direction perpendicular to the page face is improved.

### Second Embodiment

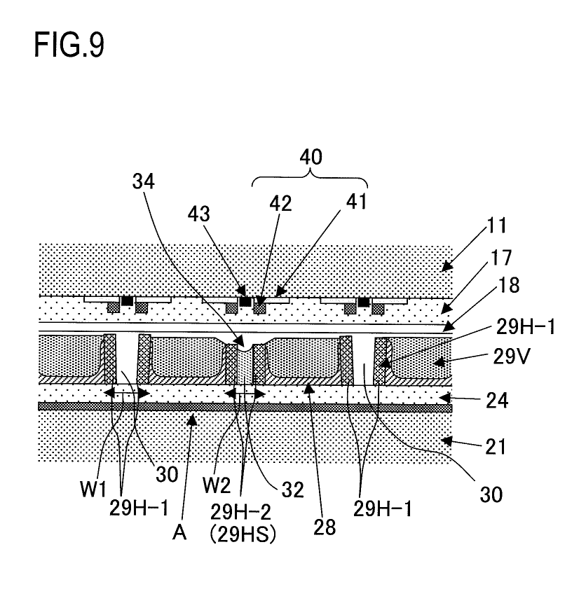

FIG. 10 is a plan view depicting lattice-shaped ribs according to a second embodiment. Just like FIG. 2 and FIG. 3, this example shows ribs having 6 unit emission areas (cells) comprised of a total of 3 horizontal ribs 29H-1 and 29H-2, which extend in the horizontal direction, and a total of 4 vertical ribs 29V, which connect these horizontal ribs and extend in the vertical direction, and these horizontal ribs and vertical ribs form a lattice-shaped structure. The width W4 of the horizontal rib 29H-2 and the ladder structure of the horizontal rib 29H-2 are also the same as FIG. 2 and FIG. 3. The difference from FIG. 2 in the rib structure in FIG. 10 is that the width W2 of the sub-vertical wall 29VS is narrower than the width W1 of the vertical rib 29V, and the width W3 of the sub-horizontal wall 29HS is also narrower than the width W1 of the vertical rib 29V.

In other words, in the case of the rib structure in FIG. 10, the width W2 of the sub-vertical wall 29VS and the width W3 of the sub-horizontal wall 29HS are formed to be partially narrower than that of other ribs, and the heights of the sub-vertical wall 29VS and the sub-horizontal wall 29HS are formed to be lower than the vertical rib 29V, so that the exhaust conductance of both the horizontal direction and the vertical direction are improved. In the rib structure in FIG. 10 as well, the width W4 of the horizontal rib 29H-2 is appropriately increased, so that the height thereof becomes lower than the vertical rib 29V and the horizontal rib 29H-1, and exhaust conductance in the vertical direction is improved, just like FIG. 2.

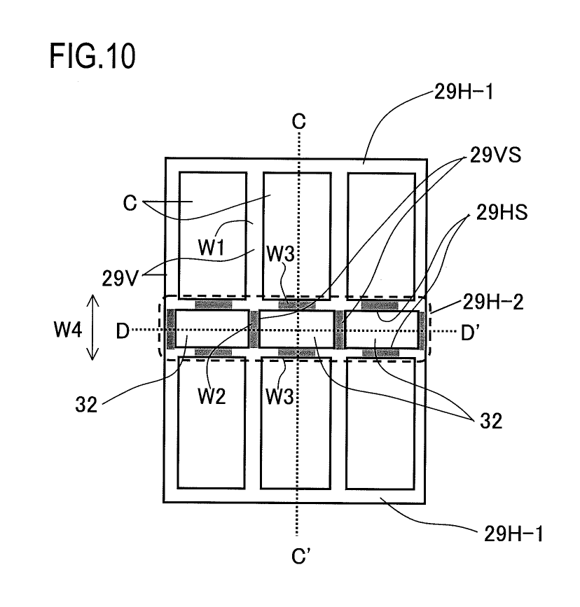

FIG. 11 shows cross-sectional views of C-C′ and D-D′ in FIG. 10. As comparison with FIG. 4 shows, in the C-C′ sectional view, the sub-vertical wall 29VS is formed to be low at the center portion, and in the D-D′ sectional view, the sub-horizontal wall 29HS is formed to be low at the center portion. In other words, the slope SLP is formed on the top of the pair of sub-horizontal walls 29HS in the C-C′ sectional view, and the slope SLP is also formed on the top of the side vertical wall 29VS in the D-D′ sectional view. Since the pair of sub-horizontal walls 29HS constituting the horizontal rib 29H-2 are formed to be low at the center portion respectively, the exhaust conductance in the vertical direction in FIG. 10 is improved.

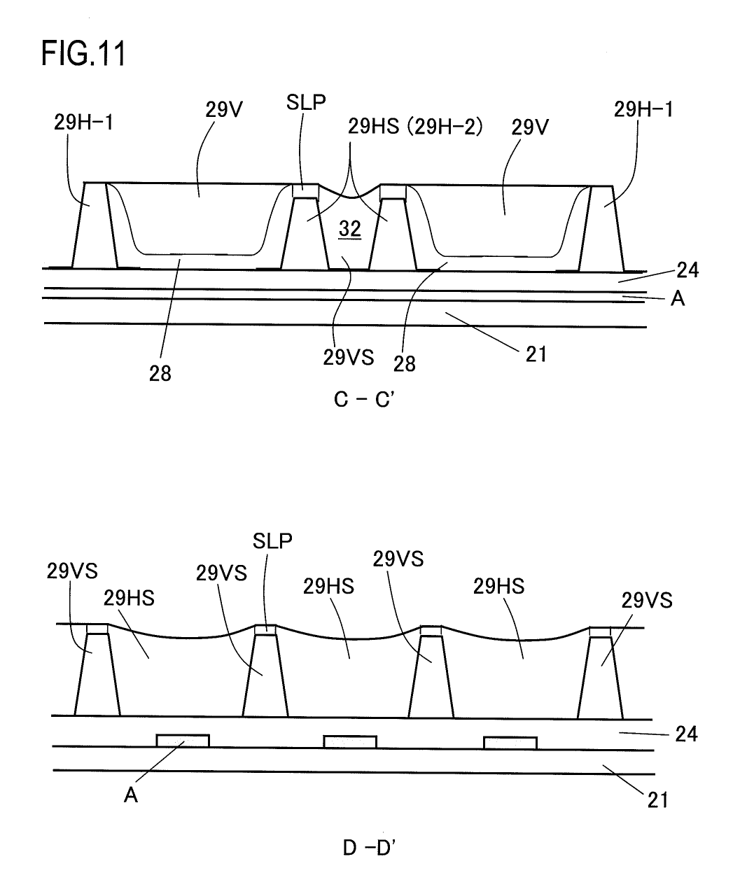

FIG. 12 is a figure showing cross-sectional views of C-C′ and D-D′ different the view in FIG. 10. As the C-C′ section view shows, the width W4 of the horizontal rib 29H-2 is formed with appropriately width, and the entire horizontal rib 29H-2 is formed to be low. Therefore along with the sub-vertical wall 29VS being formed to be low at the center portion, the exhaust conductance in the horizontal direction in FIG. 10 is further improved.

[Manufacturing Process]

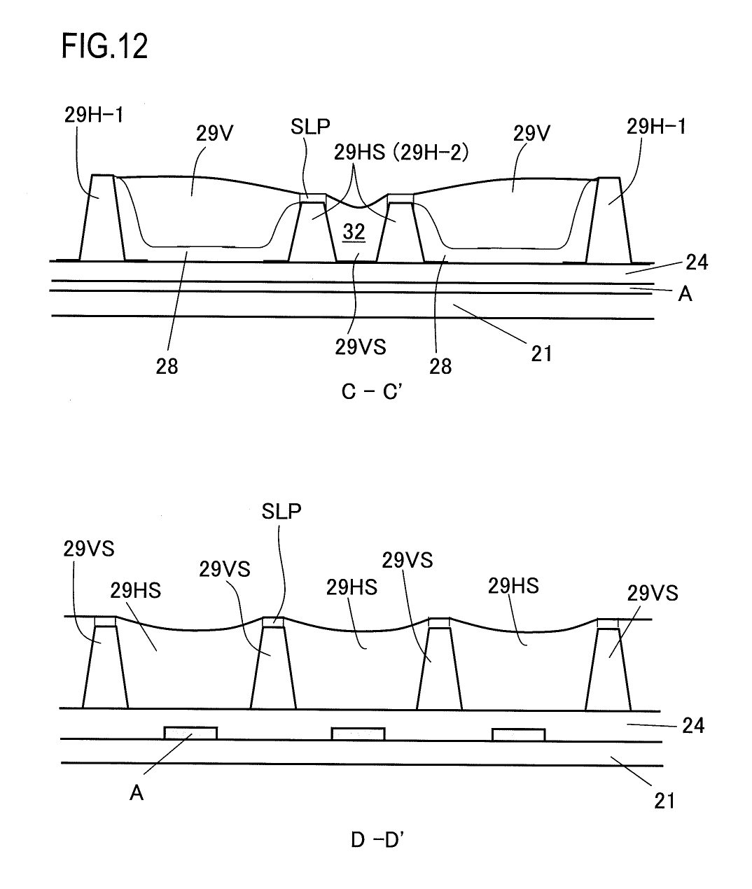

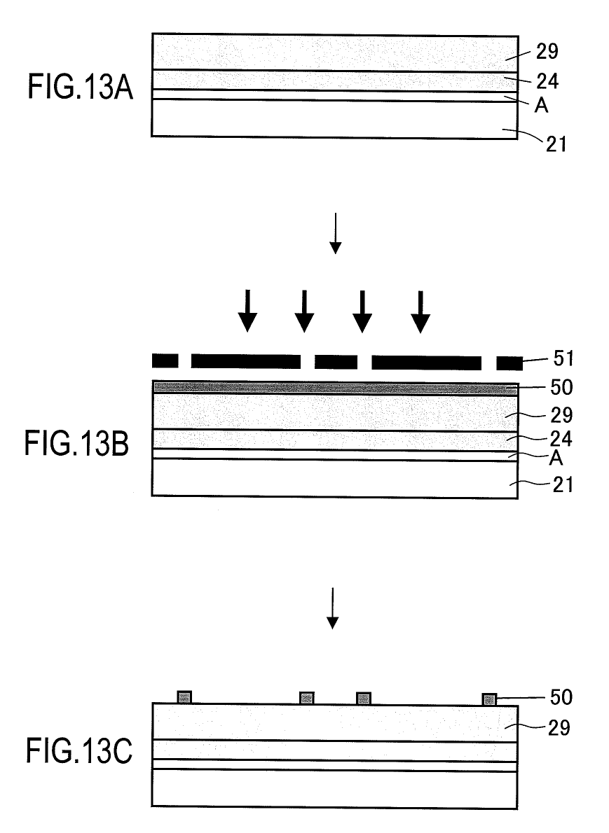

FIG. 13 and FIG. 14 are cross-sectional views depicting a manufacturing process to form the ribs of the present embodiment. As FIG. 13A shows, an address electrode A and a dielectric layer 24, which coats the address electrode A are formed on a back substrate 21 made of glass substrate, and a rib layer 29 is formed to be a 100 to 200 μm thickness, for example, using low melting point glass paste by a screen printing method or a coating method. The material components of the glass paste are: PbO 50 to 70 wt %, B₂O₃ 5 to 10 wt %, SiO₂ 10 to 30 wt %, Al₂O₃ 15 to 25 wt %, and CaO to 5 wt %, for example. Then the rib layer 29 is dried by a predetermined high temperature processing.

Then as FIG. 13B and FIG. 13C show, a dry film layer 50 is pasted on the rib layer 29, and is exposed and developed via a mask 51, thereby a dry film layer pattern 50, which is a rib pattern, is formed. And as FIG. 14D shows, the rib layer 29 is patterned by a sand blast method, using the dry film layer pattern 50 as a mask, so as to form the lattice-shaped type ribs 29, as shown in FIG. 14E.

Finally, the ribs 29 are baked by a baking processing at a peak temperature of 500 to 600° C. In this baking step, the sub-vertical wall 29VS, which is formed to be narrower than the vertical rib 29V, becomes lower in height at the center portion due to the heat contraction function during fusing. While the height of the sub-vertical wall 29VS before baking is 100 to 200 μm, the height thereof after baking is about 5 to 10 μm lower. Also the height of the horizontal rib 29H-2, comprised of a pair of sub-horizontal wall 29HS and sub-vertical wall 29VS, can be lower than that of the vertical rib 29V, by forming the width W4 of the horizontal rib 29H-2 to be an optimum narrow width, although that is not illustrated here. See FIG. 5 and FIG. 12.

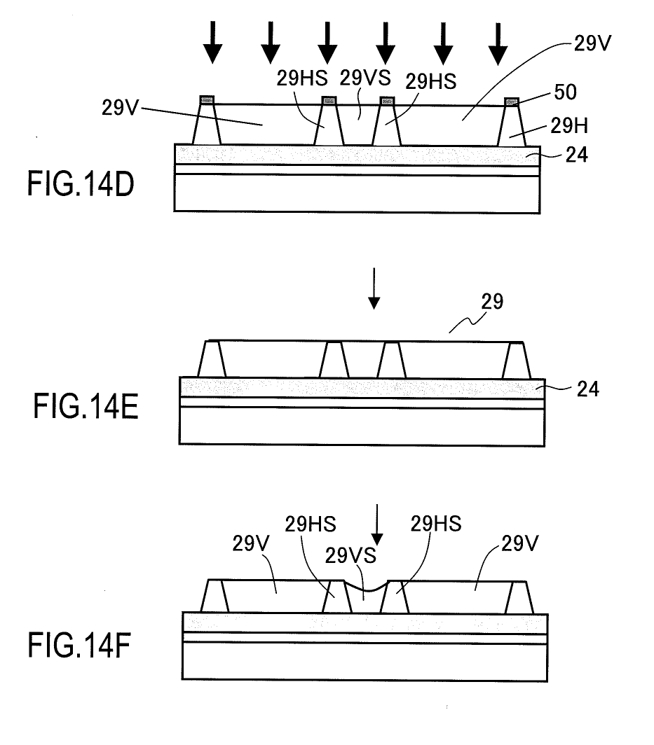

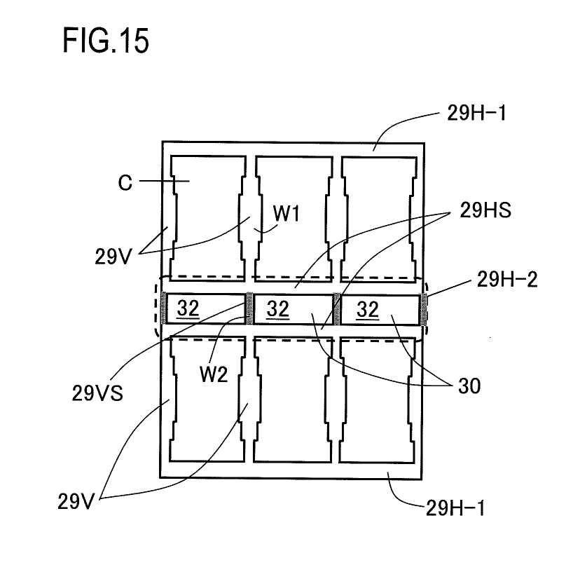

FIG. 15 and FIG. 16 are plan views depicting variant forms of the ribs according to the first embodiment. In both cases, the width W2 of the sub-vertical wall 29VS of the horizontal rib 29H-2, which is formed to be a ladder shape with the spaces 32, is narrower than the width W1 of the vertical rib 29V. In the continuation of the vertical rib 29V, sub-vertical wall 29VS and vertical rib 29V, the width gradually decreases from the width W1 of the vertical rib 29V, and becomes thinnest at the width W2 of the sub-vertical wall 29VS, then gradually returns to the original width, width W1 of the vertical rib 29V. In FIG. 15, the width W1 is decreased in steps, and in FIG. 16 the width W1 tapers off. By forming ribs like this, the height at the narrow width W2 becomes lower than that at the wide width W1, due to the heat contraction function during baking, since the heat contraction amount is greater in an area with narrow width W2 than an area with wide width W1.

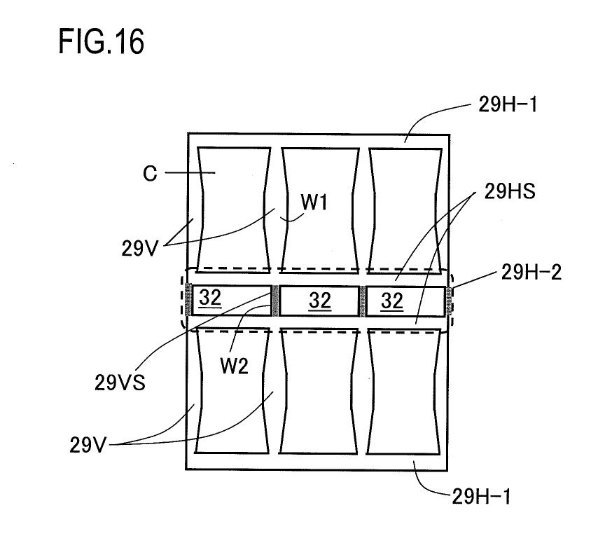

FIG. 17 is a plan view depicting a variant form of the ribs according to the second embodiment. In this example, both the sub-vertical wall 29VS and sub-horizontal wall 29HS of the horizontal rib 29H-2 are formed to be widths W2 and W3, which are narrower than the width W1 of the vertical rib 29V. The sub-horizontal wall 29HS tapers off, and the sub-vertical wall 29VS also tapers off when viewed from the vertical rib 29V side. In this case, the heights of both the sub-vertical wall 29VS and sub-horizontal wall 29HS becomes low.

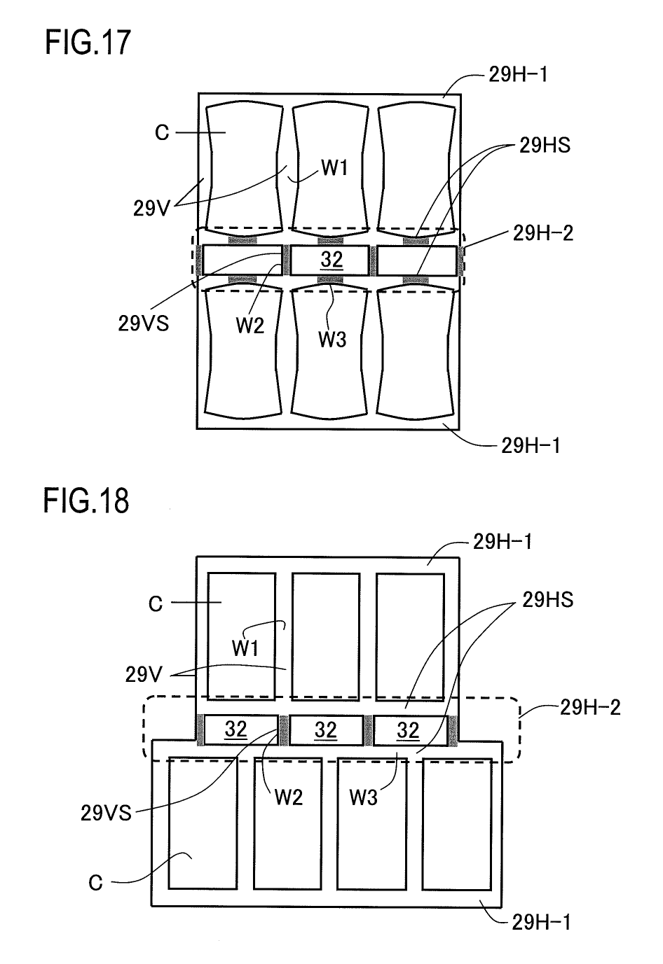

FIG. 18 is a plan view depicting a variant form of the ribs according to the first embodiment. In this example, the unit emission areas C created by the lattice-shaped ribs 29 are shifted by a half pitch between the upper row and the lower row. In this case as well, the horizontal rib 29H-2 is formed between the upper row and the lower row of the unit emission areas C, where the width W2 of the sub-vertical wall 29VS of the horizontal rib 29H-2 is formed to be narrower than the width W1 of the vertical rib 29V, thereby the height thereof is formed to be lower.

In the above mentioned embodiments, the width of the sub-vertical wall 29VS or the sub-horizontal wall 29HS of the horizontal rib 29H-2 is decreased in the lattice-shaped ribs to demarcate the unit emission areas, so that the height thereof becomes lower than that of the vertical ribs 29V due to the heat contraction function generated during the high temperature baking step. In all of these cases, the width of the ribs at the non-display portion is decreased so that the height thereof can be lower. Although the height is lower, the ribs themselves exist, so interference in a discharge between adjacent unit emission areas can be suppressed.

1. A plasma display panel, in which discharge gas is filled in a space between a pair of substrates facing each other, comprising:
a plurality of display electrodes which extend in the horizontal direction and address electrodes which extend in the vertical direction and cross with the display electrodes, formed to the pair of substrates; and
lattice-shaped ribs having vertical ribs and horizontal ribs that demarcate unit emission areas, and formed on one of the substrates, wherein
the rib has a pattern which partially becomes narrower from a first width to a second width, and returns to the first width in a plan view, so that the height of the second width portion is lower than the height of the first width portion.

2. The plasma display panel according to claim 1, wherein the second width portion is disposed in a non-emission area between the unit emission areas.

3. A plasma display panel in which discharge gas is filled in a space between a pair of substrates facing each other, comprising:
a plurality of display electrodes which extend in the horizontal direction and address electrodes which extend in the vertical direction and cross with the display electrodes, formed to the pair of substrates; and
lattice-shaped ribs having vertical ribs and horizontal ribs that demarcate unit emission areas, where the display electrodes and address electrodes cross, and formed on one of the pair of substrates, wherein
the horizontal ribs of the lattice-shaped ribs are connected by the vertical ribs, and have a ladder formation including a pair of sub-horizontal walls and sub-vertical walls connecting the sub-horizontal walls, and having a plurality of intermittent spaces inside in plan view, and
the height of the pair of sub-horizontal walls is lower than that of the vertical rib, and the width of the sub-vertical wall is narrower than the width of the vertical rib so that the height thereof is formed to be partially low.

4. The plasma display panel according to claim 3, wherein the width of the horizontal rib is wider than the width of the vertical rib.

5. The plasma display panel according to claim 4, wherein the width of the sub-horizontal wall is narrower than the width of the vertical rib so that height thereof is formed to be partially low.

6. The plasma display according to claim 3, wherein
a pair of display electrodes and one address electrode are disposed in each unit emission area,
the display electrode is formed of a transparent electrode and a bus electrode which contacts the transparent electrode, and
the bus electrode of the display electrode is disposed so as to overlap the horizontal rib.

7. The plasma display panel according to claim 6, wherein the display electrode disposed in a unit emission area is shared by an adjacent unit emission area in the vertical direction.

8. The plasma display panel according to claim 6, wherein the display electrodes disposed in the unit emission areas adjacent in the vertical direction are electrically isolated, and a pair of display electrodes are disposed in each unit emission area.

9. A plasma display panel in which discharge gas is filled in a space between a pair of substrates facing each other, comprising:
a plurality of display electrodes which extend in the horizontal direction and address electrodes which extend in the vertical direction and cross with the display electrodes, formed to the pair of substrates; and
lattice-shaped ribs having vertical ribs and horizontal ribs that demarcate unit emission areas where the display electrodes and address electrodes cross, and formed on one of the pair of substrates, wherein
the horizontal ribs of the lattice-shaped ribs are connected by the vertical ribs and have a ladder formation having a pair of sub-horizontal walls and sub-vertical walls connecting the sub-horizontal walls, and having a plurality of intermittent spaces inside in plan view, and the width of the sub-vertical wall is narrower than that of the vertical rib so that the height thereof is formed to be partially low.

10. The plasma display panel according to claim 9, wherein the width of the horizontal rib is wider than the width of the vertical rib, and the height of the pair of sub-horizontal walls is lower than that of the vertical rib.

11. The plasma display panel according to claim 9, wherein the width of the vertical rib becomes gradually narrower as the sub-vertical wall is approached.
